(19) United States
(12) Patent Application Publication
(10) Pub. No.: US 2013/0159497 A1
(43) Pub. Date: Jun. 20, 2013

(54) Heuristic-Based Rejection of Computing Resource Requests

(71) Applicants: Michael Gene Butler, Beijing (CN); Huangjian Guo, Beijing (CN); Gleb Kholodov, Seattle, WA (US); Siddhartha Mathur, Sammamish, WA (US); David Sterling, Apex, NC (US); Zhengwen Zhu, Redmond, WA (US)

(72) Inventors: Michael Gene Butler, Beijing (CN); Huangjian Guo, Beijing (CN); Gleb Kholodov, Seattle, WA (US); Siddhartha Mathur, Sammamish, WA (US); David Sterling, Apex, NC (US); Zhengwen Zhu, Redmond, WA (US)

(73) Assignee: MICROSOFT CORPORATION, Redmond, WA (US)

(21) Appl. No.: 13/328,271

(22) Filed: Dec. 16, 2011

(51) Int. Cl. G06F 15/173

(52) U.S. Cl. 709/224

(57) ABSTRACT

A computing system includes an authentication layer, the authentication layer being programmed to receive a request for resources of the computing system and to authenticate an identity of a user requesting the resources, and a command layer, the command layer being programmed to execute one or more commands from the request for resources, wherein the command layer logs characteristics associated with one or more of the commands, wherein the computing system monitors each logged command to determine when a threshold is met, and wherein the computing system blocks a subsequent request for resources from the user when the threshold is met.

### BACKGROUND

Most tasks performed by a computing system can be automated. Such automation provides users with the ability to complete large tasks in an efficient manner. However, these tasks can be resource-intensive, particularly when the tasks involve multiple requests requiring resources from multi-tiered computing systems.

For example, when a computing system having logical layers L_{1-N} receives a resource request, a fraction of computing resources is spent at each of the layers involved in the processing of the request at each respective level of abstraction (e.g., at each of the Open Systems Interconnection (OSI) levels). When a particular operation fails at a layer L_{F}, where F<N, the total computing resources spent is the sum of the resources spent at layers L_{1-F} to reach the failure at that layer. If multiple similar requests are made, such as during an automated process, and all of these requests fail for similar reasons at a certain layer, the wasted resources can be compounded by the computing system repeatedly processing similar resource requests, despite the previous request failure(s).

### SUMMARY

The present application is directed to systems and methods for using a heuristic-based approach for throttling computer-based requests.

In one aspect, a computing system includes: a processing unit; and system memory encoding instructions that, when executed by the processing unit, create: an authentication layer, the authentication layer being programmed to receive a request for resources of the computing system and to authenticate an identity of a user requesting the resources; and a command layer, the command layer being programmed to execute one or more commands from the request for resources; wherein the command layer logs characteristics associated with one or more of the commands; wherein the computing system monitors each logged command to determine when a threshold is met; and wherein the computing system blocks a subsequent request for resources from the user when the threshold is met.

In another aspect, a method for throttling requests for resources includes: receiving, by a computing device, a request for resources of a computing system; processing, by the computing device, the request to identify a characteristic of the request for resources; comparing the characteristic to a list; when the characteristic is found on the list, blocking the request; and when the characteristic is absent from the list, passing the request on for further processing.

In yet another aspect, a physical computer-readable storage medium encodes instructions that, when executed by the processing unit, cause the processing unit to perform steps including: receiving, by a computing device, a request for resources of a computing system; processing the request to identify a characteristic of the request for resources; comparing the characteristic to a list; when the characteristic is not found on the list: authenticating an identity of a user making the request for resources; authorizing the user for access to the resources; providing access to the requested resources; logging a failure while authorizing or providing access to the requested resources; and creating the list to include one or more characteristics associated with the failure, the characteristics including a user identification of the user; and when the characteristic is found on the list, blocking the request, the request being blocked prior to authentication or authorization of a user making the request.

This Summary is provided to introduce a selection of concepts, in a simplified form, that are further described below in the Detailed Description. This Summary is not intended to identify key or essential features of the claimed subject matter, nor is it intended to be used in any way to limit the scope of the claimed subject matter.

### DESCRIPTION OF THE DRAWINGS

Aspects of the present disclosure may be more completely understood in consideration of the following detailed description of various embodiments in connection with the accompanying drawings.

FIG. 1 shows an example networked computing environment.

FIG. 2 shows example components of a server device of the networked computing environment of FIG. 1.

FIG. 3 shows example components of a client device of the networked computing environment of FIG. 1.

FIG. 4 shows another example networked computing environment.

FIG. 5 shows example layers of server devices of the networked computing environment of FIG. 4.

FIG. 6 shows an example method for throttling computer-based resource requests.

FIG. 7 shows an example blacklist.

### DETAILED DESCRIPTION

The present disclosure is directed towards systems and methods for using a heuristic-based approach for throttling computer-based requests. Such requests can be rejected, as described in the examples herein, to minimize resources that are wasted on requests that have an estimated likelihood of failure. Although not so limited, an appreciation of the various aspects of the present disclosure will be gained through a discussion of the examples provided below.

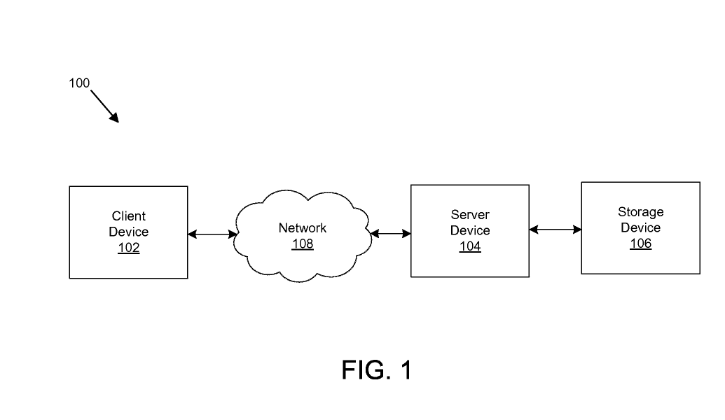

Referring now to FIG. 1, an example networked computing environment 100 is shown in which aspects of the present disclosure may be implemented. The networked computing environment 100 includes a client device 102, a server device 104, a storage device 106, and a network 108. Other embodiments are possible. For example, the networked computing environment 100 may generally include more or fewer devices, networks, and/or other components as desired.

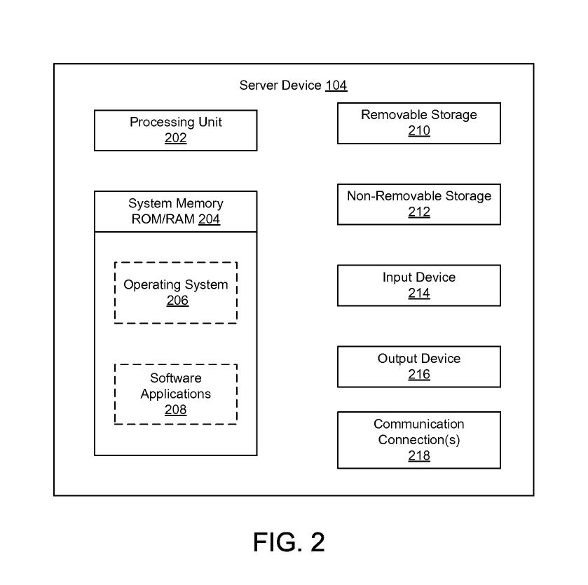

The client device 102 and the server device 104 are computing devices, described in further detail below in connection with FIG. 2. In example embodiments, the client device 102 is configured for accessing and interacting with business processes implemented by the server device 104. Example business processes include messaging and communications processes, collaboration processes, data management processes, and others. Exchange Server, from Microsoft Corporation of Redmond, Washington, is an example of a business server that implements messaging and communications business processes in support of electronic mail, calendaring, and contacts and tasks features, in support of mobile and web-based access to information, and in support of data storage. Other embodiments are possible.

For example, in one embodiment, the client device 102 is a computing device running a scripting program, such as the Windows PowerShell scripting program offered by Microsoft Corporation. Such a scripting program allows for tasks to be automated. For example, the client device 102 can use a scripting program like the Windows PowerShell scripting program to automate the access of information stored on the server device 104. Such tasks can include access of and manipulation of electronic mailboxes stored on an Exchange Server of the server device 104.

For instance, in one example, the client device 102 send hundreds or thousands of requests (sometimes referred to as “commandlets”) to the server device 104 requesting information from the electronic mailboxes, such as the SMTP address associated with each of the mailboxes. Each request for each mailbox SMTP address can involve multiple layers of authentication, authorization, and processing to obtain the desired information. Such authentication, authorization, and processing can also be accomplished by different programs running on different servers, further increasing the resource-intensive nature of the requests. By throttling requests that have a certain likelihood of failure, the amount of resources that are wasted on processing those requests can be minimized, as described further herein.

In some embodiments, the server device 104 includes of a plurality of interconnected, networked server devices operating together to share resources, software, and information. In such a scenario, the networked devices provide a “cloud” computing platform in which one or more applications and data are hosted for one or more clients connected to the cloud computing platform. Still other embodiments are possible.

The storage device 106 is an electronic data storage device, such as a relational database or any other type of persistent data storage device. The storage device 106 stores data in a predefined format such that the server device 104 can query, modify, and manage data stored thereon. Example data includes information related to directory services, authentication services, administration services, and other services such as managed by the ACTIVE DIRECTORY® directory service from Microsoft Corporation. Other embodiments are possible.

The network 108 is a bi-directional data communication path for data transfer between one or more devices. In the example shown, the network 108 establishes a communication path for data transfer between the client device 102 and the server device 104. The network 108 can be of any of a number of wireless or hardwired WAN, LAN, Internet, Intranet, or other packet-based communication networks such that data can be transferred among the elements of the example networked computing environment 100.

Referring now to FIG. 2, the server device 104 of FIG. 1 is shown in detail. As mentioned above, the server device 104 is a computing device. Examples of computing devices include server computers, desktop computers, laptop computers, personal data assistants, smartphones, gaming consoles, and others.

The server device 104 includes at least one processing unit 202 (sometimes referred to as a processor) and a system memory 204. The system memory 204 stores an operating system 206 for controlling the operation of the server device 104 or another computing device. One example operating system is the WINDOWS® operating system from Microsoft Corporation. Other embodiments are possible.

The system memory 204 includes one or more software applications 208 and may include program data. Software applications 208 may include many different types of single and multiple-functionality programs, such as a server program, an electronic mail program, a calendaring program, an Internet browsing program, a spreadsheet program, a program to track and report information, a word processing program, scripting programs, and many others. One example program is the Office suite of business applications from Microsoft Corporation. Another example program includes SHAREPOINT® collaboration server or Exchange Server, also from Microsoft Corporation of Redmond, Wash. Still other programs are possible.

The system memory 204 is computer-readable media. Examples of computer-readable media include computer-readable storage media and communication media. Computer-readable storage media is physical media that is distinguished from communication media.

The phrase “computer-readable” generally refers to information that can be interpreted and acted on by a computing device. The phrase “storage media” or, equivalently, “storage medium” refers to the various types of physical or tangible material on which electronic data bits are written and stored. Since it is not possible to store information in a transient signal, “computer-readable storage media” as defined within the context of the present disclosure excludes transient signals.

Computer-readable storage media includes physical volatile and nonvolatile, removable and non-removable media implemented in any method or technology for storage of information, such as computer-readable instructions, data structures, program modules, or other data. Computer storage media also includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the server device 104. Any such computer storage media may be part of or external to the server device 104. Such storage is illustrated in FIG. 2 by removable storage 210 and non-removable storage 212.

Communication media is typically embodied by computer-readable instructions, data structures, program modules, or other data, in a transient modulated data signal, such as a carrier wave or other transport mechanism, and includes any information delivery media. The term “modulated data signal” refers to a signal that has one or more of its characteristics set or changed in such a manner as to encode information in the signal. By way of example, communication media includes wired media such as a wired network or direct-wired connection, and wireless media such as acoustic, RF, infrared and other wireless media.

The server device 104 also includes any number and type of an input device 214 and an output device 216. An example input device 214 includes a keyboard, mouse, pen, voice input device, touch input device, motion input device, and others. For example, the input device 214 may be a camera operative to capture and record motions and/or gestures made by a user. The input device 214 may be further operative to capture words spoken by a user, such as by a microphone, and/or capture other inputs from user such as by a keyboard and/or mouse.

Consistent with embodiments of the present disclosure, the input device 214 may comprise any motion detection device capable of detecting the movement of a user. For example, the input device 214 may comprise a KINECT® motion capture device, from Microsoft Corporation. Other embodiments are possible.

An example output device 216 includes a display, speakers, printer, and others. The server device 104 also includes a communication connection 218 configured to enable communications with other computing devices over a network (e.g., network 108 of FIG. 1) in a distributed computing system environment.

The client device 102 can be configured in a manner similar to that of the server device 104 described above.

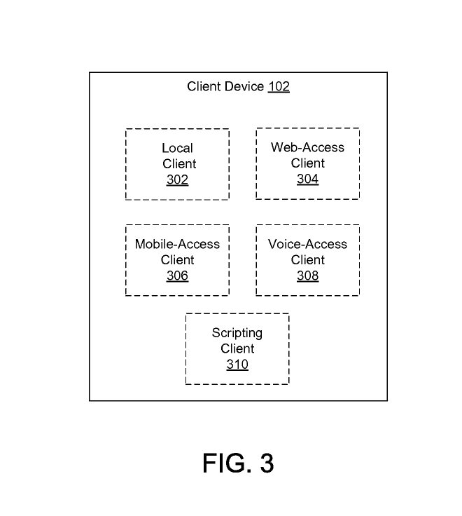

Referring now to FIG. 3, example logical modules of the client device 102 are shown. The client device 102 is configured to include one or more different types of client interfaces to access functionality of the server device 104. In the example shown, the client device 102 includes a local client 302, a web-access client 304, a mobile-access client 306, a voice-access client 308, and a scripting client 310. Other types of client interfaces to the server device 104 are possible as well.

The local client 302 is configured as a dedicated messaging and collaboration client that serves as an interface to the server device 104, and is part of a suite of applications executing on the client device 102. In one embodiment, the local client 302 includes the OUTLOOK® messaging and collaboration client, an e-mail application that is part of the Office suite from Microsoft Corporation. A user can compose, interact with, send and receive e-mails with the OUTLOOK® messaging and collaboration client. Other embodiments of the local client 302 are possible. For example, in one embodiment, the local client 302 includes the Office Communicator client from Microsoft Corporation, an instant messaging client used with Office Communications Server. Still other embodiments of the local client 302 are possible as well.

The web-access client 304 is configured to accesses the server device 104 remotely using a network connection, such as the Internet. In one embodiment, the web-access client 304 is the Outlook Web Access (OWA) webmail service of Exchange Server. In the example embodiment, the client device 102 uses a web browser to connect to Exchange Server via Outlook Web Access. This brings up a user interface similar to the interface in the OUTLOOK® messaging and collaboration client in which a user can compose, interact with, send and receive e-mails. Other embodiments of the web-access client 304 are possible. For example, the web-access client 304 may be configured to connect to SHAREPOINT® collaboration server to access corresponding collaboration, file sharing and web publishing services. Still other embodiments of the web-access client 304 are possible.

The mobile-access client 306 is another type of client interface to the server device 104. In one embodiment, the mobile-access client 306 includes the Mobile Access with ACTIVESYNC® synchronization technology or the Windows Mobile Device Center for WINDOWS VISTA® operating system or Windows 7 operating system, all from Microsoft Corporation. Example mobile devices include a cellular telephone, smartphone, a personal digital assistant, and many others. Other embodiments of the mobile-access client 306 are possible.

The voice-access client 308 is yet another type of client interface to the server device 104. In some embodiments, the voice-access client 308 includes Exchange Unified Messaging that is supported in Exchange Server. With Unified Messaging, users have one inbox for e-mail and voicemail. Voicemails are delivered directly into the OUTLOOK® messaging and collaboration client inbox. The message containing the voicemails may also include an attachment (e.g., an electronic document). Other embodiments of the voice-access client 308 are possible.

The scripting client 310 is another client interface that allows the user to automate certain tasks. For example, the scripting client 310 can be the Windows PowerShell scripting program offered by Microsoft Corporation. The scripting client 310 can automate access to the server device 104 and manipulation of information stored on the storage device 106. By leveraging the scripting capabilities of the scripting client 310, the user can request hundreds, thousands, or a greater number of tasks to be performed automatically by the server device 104. For example, as noted above, the scripting client 310 can be used by the user to access information stored in an Exchange Server hosted on the server device 104.

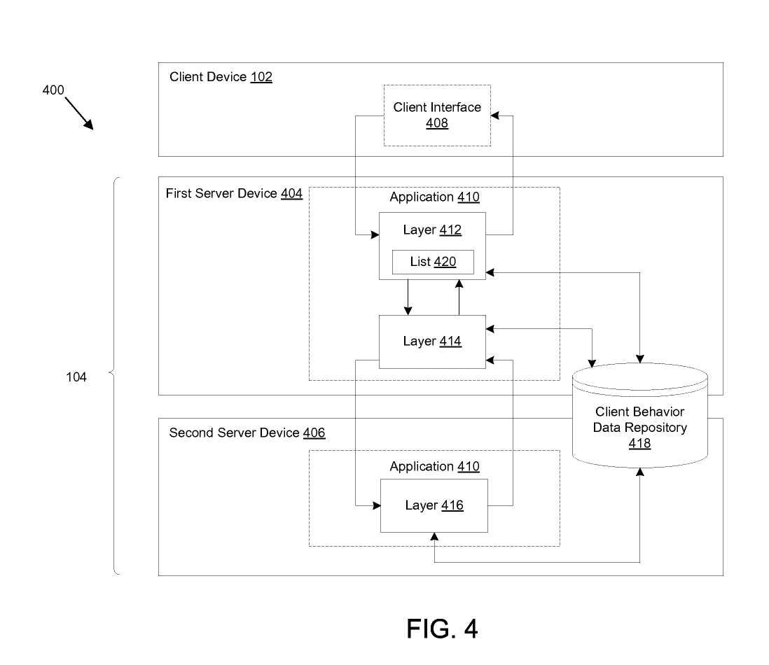

Referring now to FIG. 4, an example networked computing environment 400 is shown. The networked computing environment 400 is similar to that of 100 described above, and includes the client device 102 and the server device 104. The server device 104 is actually two server devices, a first server device 404 and a second server device 406 in communication with each other.

In this example, the client device 102 includes a client interface 408 that allows the user of the client device 102 to send requests to the server device 104. For example, the client interface 408 can be a scripting program that automates a plurality of requests that are sent by the client device 102 to the server device 104.

An application on the first server device 404 receives the requests from the client interface 408 of the client device 102. The first server device 404 processes each request through a plurality of layers 412, 414 on the first server device 404. Each layer 412, 414 performs different functions on the request, such as authentication and authorization, as described further below.

In addition, one or more of the requests made by the client device 102 requires that the application 410 call one or more processes on the second server device 406. In this example, this includes an application 410 on the second server device 406. An example of the application 410 is the Exchange Server, which performs tasks associated with electronic mailboxes managed therein. The second server device 406 must, in turn, process the requests from the first server device 404 through one or more layers, such as a layer 416.

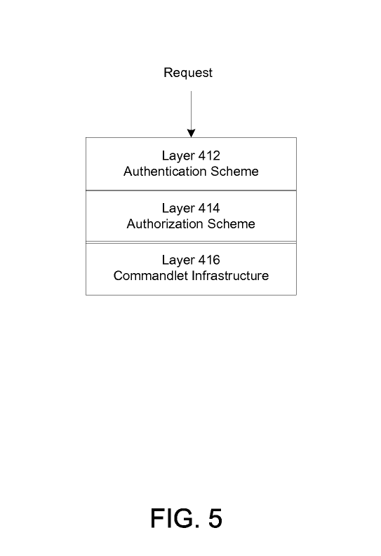

For example, referring now to FIG. 5, the different layers used to process the request from the client interface 408 are shown.

In this example, the layer 412 is an authentication scheme. This authentication scheme can involve a variety of logic, such as identification of the user making the request (e.g., AuthN).

The layer 414 is an authorization scheme. This authorization scheme can involve a variety of logic, such as determining that the user has permission to access the requested resources (e.g., AuthZ/WS-MAN).

The layer 416 is a command layer involving a commandlet infrastructure. In this example, the commandlet infrastructure is implemented by an Exchange Server, and the commandlet infrastructure performs various tasks at the Exchange Server, such as obtaining and modifying information stored in the Exchange Server.

When a request is made, the request is passed through layers 412, 414, 416 as described above. Each request, absent the throttling described herein, would penetrate each layer until the request fails at a given layer.

For example, if a request is made with proper credentials, the request may be processed successfully and “pass through” layers 412 and 414. However, if the request includes an improper commandlet (e.g., a malformed commandlet, etc.), the request would fail at the layer 416. If a plurality of similar requests is sent, each request would be processed by the layers 412, 416 before failing at the layer 416, absent the throttling described herein.

Referring back to FIG. 4, the networked computing environment 400 also includes a client behavior data repository 418. In this example, the client behavior data repository 418 can be stored on the first and/or second server devices 404, 406, or on an independent storage device. The layers 412, 414, 416 of the first and second server devices 404, 406 communicate with the client behavior data repository 418 to provide information about requests made by clients, such as the client device 102.

For example, as each of the layers 412, 414, 416 processes requests, the layers 412, 414, 416 can communicate failures to the client behavior data repository 418. Such communications can include identification information associated with the users that provided the failed requests. The client behavior data repository 418 logs the failures and uses various heuristics to determine trends for the failures and possible throttling of future requests, as noted below.

In generally, reduction of the amount of computing resources spent in the failure cases is achieved by lowering “f”—the layer at which a failure occurs. This is achieved through introduction of a feedback loop (i.e., the client behavior data repository 418) from deeper layers (e.g., 414, 416) into a new layer “x” (where 412<414<416). Layer 412 correlates information available at its level of abstraction with outcome reported by subsequent layers (414, 416) for future requests R(. . . m) to predict and preventatively reject a subset of future requests R(m+1 . . . ) that are likely to fail. This results in performance savings of 1 . . . A times, depending on heuristics used in the layer 412.

Examples of heuristics include: (i) reject all Connect requests from a user if N of the user's previous requests processed in the past M minutes ended with an HTTP failure; and (ii) reject all requests for users located in resource X if more than N % of requests processed in the past M minutes that involved resource X also failed. Other examples are provided below.

For example, if the number of requests that fail at the layer 414 for a given user reaches and/or exceeds a given threshold, the client behavior data repository 418 can identify such a situation and communicate this information to one or more of the layers 412, 414, 416 to provide throttling on future requests from the given user.

In this example, request types that exceed one or more thresholds, as monitored by the client behavior data repository 418, are placed as entries on a “blacklist” for the networked computing environment 400. This blacklist is communicated to the layer 412 as a list 420. The list 420 can include various identifying information about the failed requests, such as the user making the requests, the type of request, the reason for failure, etc.

When another request is received, the layer 412 checks the characteristics of the request against the list 420 to see if the request matches any of the entries on the list. For example, if the request is from a user that has already met thresholds for failures in one of the layers 414, 416, the user's identification (e.g., user name, etc.) is provided on the list 420. This can include, for example, decoding the request to access the user key associated with the request.

When the layer 412 identifies a match in the list 420, the layer 412 blocks the request. This can save on further resources that would ordinarily need to process the request before failure, such as the resources associated with the layers 414, 416.

The thresholds can be configured in various manners. For example, as described herein, the thresholds can be based on the number of failed requests made by a user in a given period of time. For example, if a user makes 100 failed requests in an hour, the user may be blacklisted from making future requests. In another example, the thresholding is based on a requested resource, instead of a specific user. For example, if resource X is requested 100 times and fails, future requests by any user for that resource X can be throttled. Other examples are possible.

In other embodiments, not only request failures are logged. Other request characteristics can be logged, such as the rate at which requests are made. For example, if X requests are made in a given amount of time Y, further requests can be blocked for a period of time to save resources for other users.

In yet other examples, other parameters can be used to reject requests. For example, requests can be rejected prior to authentication of the user. For example, requests can be block based on parameters such as IP address, size of the request itself, etc. In this manner, the resources associated with the process of authentication can be saved by using pre-authenticated characteristics to reject the request. Other configurations are possible.

In examples, the blacklisting can be limited in duration. For example, the throttling can be based on time, such as rejecting requests for 1, 2, 5, or 10 minutes, or for a period of hours, such as 4, 6, 12, or 24 hours or longer before allowing future requests by the user or for that resource. In another example, the throttling can be based on the number of requests, such as by rejecting the next N requests, where N is a number such as 100, 1,000, 10,000, etc. Other thresholding can be used, such as more complex algorithms that examine multiple characteristics like time of day, number of users, freedom of resources, etc.

In examples, the list 420 can be pushed to the layer 412 by the client behavior data repository 418, or can be pulled periodically by the layer 412. In some examples, the list 420 is updated in real time, or periodically over time. For example, the list 420 can be updated at a periodic interval, such as every 2, 5, 10, or 15 minutes. In this manner, the need for throttling requests is balanced against the resources needed to maintain and communicate the list 420 to one or more of the layers 412, 414, 416.

In alternatives embodiments, other configurations can be used. For example, instead of maintaining the list 420, the layer 412 can simply query the client behavior data repository 418 directly each time a request is received to determine whether or not to throttle the request. In yet another example, each of the layers 412, 414, 416 can maintain a blacklist and communicate the list to the other layers.

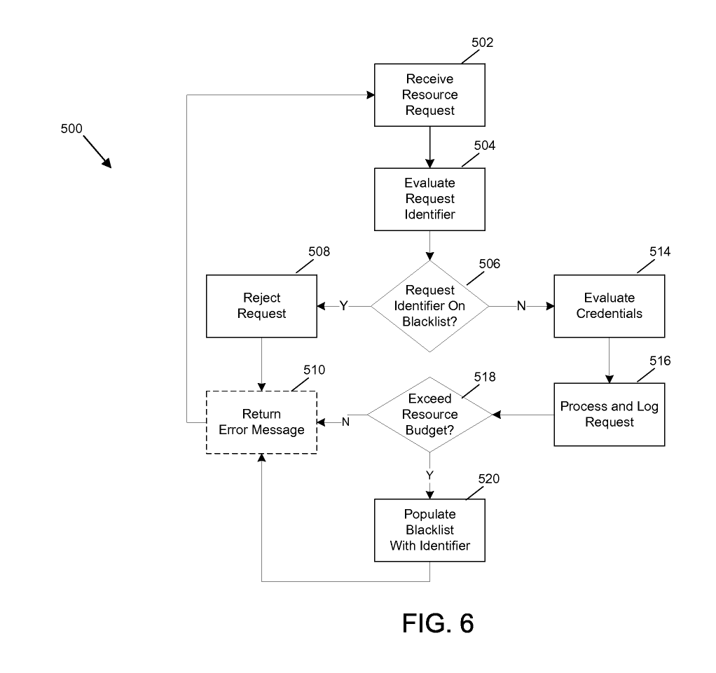

Referring now to FIG. 6, an example method 500 for throttling requests is shown. At operation 502, a request for a particular resource is received. Next, at operation 504, specific characteristics associated with the request are examined, such as a key associated with the requesting user. Next, at operation 506, those characteristics are compared to the blacklist to determine if any matches exist.

If a match does exist, control is passed to operation 508, and the request is rejected. Optionally, at operation 510, an error message can be provided to the requesting user. Control is then passed back to operation 502 for the next request.

If, conversely, there is no match on the blacklist at operation 506, control is passed to operations 514, 516 to process the request. This processing can include authenticating the user making the request, and performed the tasks and/or providing the resources requested.

Next, at operation 518, a determination of whether or not a particular failure when processing the request meets a given threshold is performed. If not, control is passed to optional operation 510, where an error message is given. If a threshold is met by a failure during process of the request, control is passed to operation 520, and the characteristics associated with the request are placed on the blacklist.

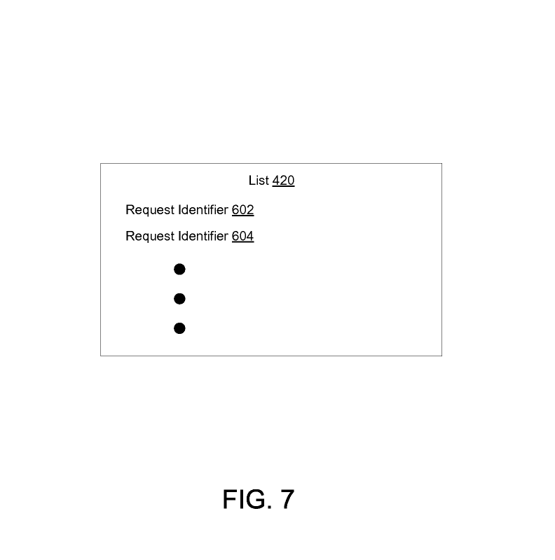

Referring now to FIG. 7, the example list 420 is shown. In this list 420, identifiers of particular requests are provided so that future requests can be throttled. Examples of such characteristics include user identifiers (e.g., user name, such as the Windows LiveID of a particular user), resource identifiers (e.g., specific resources on the server device 104), etc. In this example, the list 420 includes request identifiers 602, 604. The request identifiers can include various information, such as user names and other parameters, such as the time of the request, etc. As noted above, the list 420 is used as a blacklist to throttle requests that are estimated to have a higher likelihood to fail.

The example embodiments described herein can be implemented as logical operations in a computing device in a networked computing system environment. The logical operations can be implemented as: (i) a sequence of computer implemented instructions, steps, or program modules running on a computing device; and (ii) interconnected logic or hardware modules running within a computing device.

For example, the logical operations can be implemented as algorithms in software, firmware, analog/digital circuitry, and/or any combination thereof, without deviating from the scope of the present disclosure. The software, firmware, or similar sequence of computer instructions can be encoded and stored upon a computer-readable storage medium and can also be encoded within a carrier-wave signal for transmission between computing devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a processing unit; and
system memory encoding instructions that, when executed by the processing unit, create:
an authentication layer, the authentication layer being programmed to receive a request for resources of the computing system and to authenticate an identity of a user requesting the resources; and
a command layer, the command layer being programmed to execute one or more commands from the request for resources;
wherein the command layer logs characteristics associated with one or more of the commands;
wherein the computing system monitors each logged command to determine when a threshold is met; and
wherein the computing system blocks a subsequent request for resources from the user when the threshold is met.

2. The computing system of claim 1, wherein the command layer logs each failed command, the computing system monitors each failed command to determine when the threshold is met, and the authentication layer blocks the subsequent request for resources.

3. The computing system of claim 2, further comprising:
an authorization layer, the authorization layer being programmed to receive the request for resources of the computing system and to authorize the user to access the resources;
wherein the authorization layer logs each failed authorization.

4. The computing system of claim 3, wherein characteristics associated with the failed command and the failed authorization are stored in a repository.

5. The computing system of claim 4, wherein a blacklist is created based upon information in the repository.

6. The computing system of claim 5, wherein the blacklist includes at least one entry, the entry including characteristics associated with the user having exceeded the threshold.

7. The computing system of claim 2, wherein characteristics associated with the failed command are stored in a repository, and wherein a blacklist is created based on information in the repository.

8. The computing system of claim 7, wherein the blacklist includes at least one entry, the entry including characteristics associated with the user having exceeded the threshold, including at least a user identification.

9. The computing system of claim 7, wherein the blacklist is pushed to the authentication layer.

10. A method for throttling requests for resources, the method comprising:
receiving, by a computing device, a request for resources of a computing system;
processing, by the computing device, the request to identify a characteristic of the request for resources;
comparing the characteristic to a list;
when the characteristic is found on the list, blocking the request; and
when the characteristic is absent from the list, passing the request on for further processing.

11. The method of claim 10, wherein passing the request on for further processing includes authenticating an identity of a user making the request for resources.

12. The method of claim 11, wherein passing the request on for further processing includes providing access to the requested resources.

13. The method of claim 12, wherein passing the request on for further processing includes authorizing the user for access to the resources.

14. The method of claim 13, wherein passing the request on for further processing includes logging a failure while authorizing or providing access to the requested resources.

15. The method of claim 14, further comprising creating the list to include one or more characteristics associated with the failure.

16. The method of claim 15, further comprising identifying the characteristics to include a user identification of the user.

17. The method of claim 10, wherein the request is blocked prior to authentication of a user making the request.

18. The method of claim 17, wherein the request is blocked prior to authorization of the request or execution of the request.

19. A physical computer-readable storage medium encoding instructions that, when executed by a processing unit, cause the processing unit to perform steps including:
receiving, by a computing device, a request for resources of a computing system;
processing the request to identify a characteristic of the request for resources;
comparing the characteristic to a list;
when the characteristic is not found on the list:
authenticating an identity of a user making the request for resources;
authorizing the user for access to the resources;
providing access to the requested resources;
logging a failure while authorizing or providing access to the requested resources; and
creating the list to include one or more characteristics associated with the failure, the characteristics including a user identification of the user; and
when the characteristic is found on the list, blocking the request, the request being blocked prior to authentication or authorization of the user making the request.

20. The physical computer-readable storage medium of claim 19, wherein the request is blocked prior to execution of the request.
